(19) United States
(12) Patent Application Publication
(10) Pub. No.: US 2025/0097664 A1
(43) Pub. Date: Mar. 20, 2025

(54) SYSTEMS AND METHODS FOR MACHINE LEARNING BASED LOCATION AND DIRECTIONS FOR VENUE AND CAMPUS NETWORKS

(71) Applicant: CommScope Technologies LLC, Claremont, NC (US)

(72) Inventors: Harsha Hegde, Hawthorn Woods, IL (US); Milind Kulkarni, Hawthorn Woods, IL (US); Raymond Zachary Lovell, Lowell, MA (US)

(73) Assignee: CommScope Technologies LLC, Claremont, NC (US)

(21) Appl. No.: 18/727,611

(22) PCT Filed: May 15, 2023
(86) PCT No.: PCT/US2023/022262

§ 371 Date: Jul. 9, 2024

Related U.S. Application Data
(60) Provisional application No. 63/348,431, filed on Jun. 2, 2022.

(51) Int. Cl. H04W 4/021; H04W 4/90

(52) U.S. Cl. CPC H04W 4/021; H04W 4/90

(57) ABSTRACT

Systems and methods for providing machine learning based location and directions for venue and campus network are provided. In one example, a system includes a BBU entity and RU(s) communicatively coupled to the BBU entity. The system further includes antenna(s) communicatively coupled to the RU(s), and each respective RU is communicatively coupled to a respective subset of the antenna(s). The BBU entity, the RU(s), and the antenna(s) are configured to implement a base station for wirelessly communicating with UEs in a cell. The system further includes a machine learning computing system configured to receive time and location data and determine a predicted density for location areas in the cell based on the time and location data. The system is configured to determine a target location based on the predicted density for the location areas in the cell and send the target location to a first UE in the cell

### CROSS-REFERENCE TO RELATED APPLICATIONS

This application claims priority to U.S. Provisional Application No. 63/348,431, filed on Jun. 2, 2022, and titled “SYSTEMS AND METHODS FOR MACHINE LEARNING BASED LOCATION AND DIRECTIONS FOR VENUE AND CAMPUS NETWORKS,” the contents of which are incorporated herein by reference in their entirety.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to herein simply as “BBUs”) interact with multiple radio units (also referred to here as “RUs,” “remote units,” “radio points,” or “RPs”) in order to provide wireless service to various items of user equipment (UEs). The one or more BBU entities may comprise a single entity (sometimes referred to as a “baseband controller” or simply a “baseband band unit” or “BBU”) that performs Layer-3, Layer-2, and some Layer-1 processing for the cell. The one or more BBU entities may also comprise multiple entities, for example, one or more central units (CU) entities that implement Layer-3 and non-time critical Layer-2 functions for the associated base station and one or more distributed units (DUs) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the physical layer functions for the associated base station that are not implemented in the DU. The multiple radio units may be located remotely from each other (that is, the multiple radio units are not co-located) or collocated (for example, in instances where each radio unit processes different carriers or time slices), and the one or more BBU entities are communicatively coupled to the radio units over a fronthaul network.

### SUMMARY

In some aspects, a system includes at least one baseband unit (BBU) entity and one or more radio units communicatively coupled to the at least one BBU entity. The system further includes one or more antennas communicatively coupled to the one or more radio units, and each respective radio unit of the one or more radio units is communicatively coupled to a respective subset of the one or more antennas. The at least one BBU entity, the one or more radio units, and the one or more antennas are configured to implement a base station for wirelessly communicating with user equipment in a cell. The system further includes a machine learning computing system configured to receive time and location data and determine a predicted density for a plurality of location areas in the cell based on the time and location data. The system is configured to determine a target location based on the predicted density for the plurality of location areas in the cell and send the target location to a first user equipment in the cell.

In some aspects, a method includes receiving time data and location data. The method further includes determining a predicted density for a plurality of location areas in a cell based on the time data and the location data. At least one baseband unit (BBU) entity, one or more radio units, and one or more antennas are configured to implement a base station for wirelessly communicating with user equipment in the cell. The one or more radio units communicatively coupled to the at least one BBU entity, and the one or more antennas are communicatively coupled to the one or more radio units. Each respective radio unit of the one or more radio units is communicatively coupled to a respective subset of the one or more antennas. The method further includes determining a target location based on the predicted density for the plurality of location areas in the cell. The method further includes sending the target location to a first user equipment in the cell.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1B are block diagrams illustrating example radio access networks;

FIG. 2 is a diagram of example variables for machine learning model;

FIG. 3 is a block diagram illustrating an example radio access network;

FIG. 4 illustrates a flow diagram of an example method of providing a target location and directions for venue and campus networks; and

FIGS. 5A-5B illustrate a flow diagram of an example method of providing a target location and directions for venue and campus networks.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In fifth generation (5G) New Radio (NR) campus and venue networks, radio units are placed at different points based on the expected coverage and capacity needs during the initial deployment. The location of the radio units is determined based on the expected number of users and the associated traffic at different points within the campus or venue. During emergencies (for example, E911 calls, Earthquake and Tsunami Warning System (ETWS) alerts, Commercial Mobile Alert System (CMAS) alerts, weather alerts, etc.), the location of a UE can be determined by the network independent of the UE, with assistance from the UE, or directly from the UE. However, when alerts are sent out, the alerts do not provide detailed locations, services, or directions in a campus or venue that are specific to emergencies or based on traffic patterns. Moreover, the end users may not know how or where to seek shelter, what action to take, or how to share their location with first responders during emergencies based on the limited information in the alerts.

While the problems described above involve 5G NR systems, similar problems exist in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

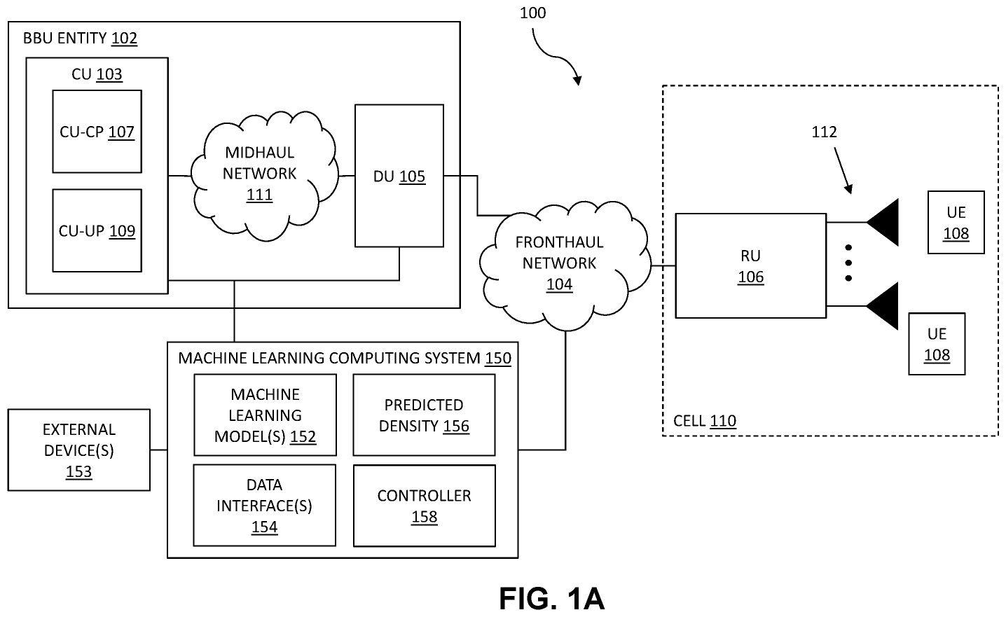

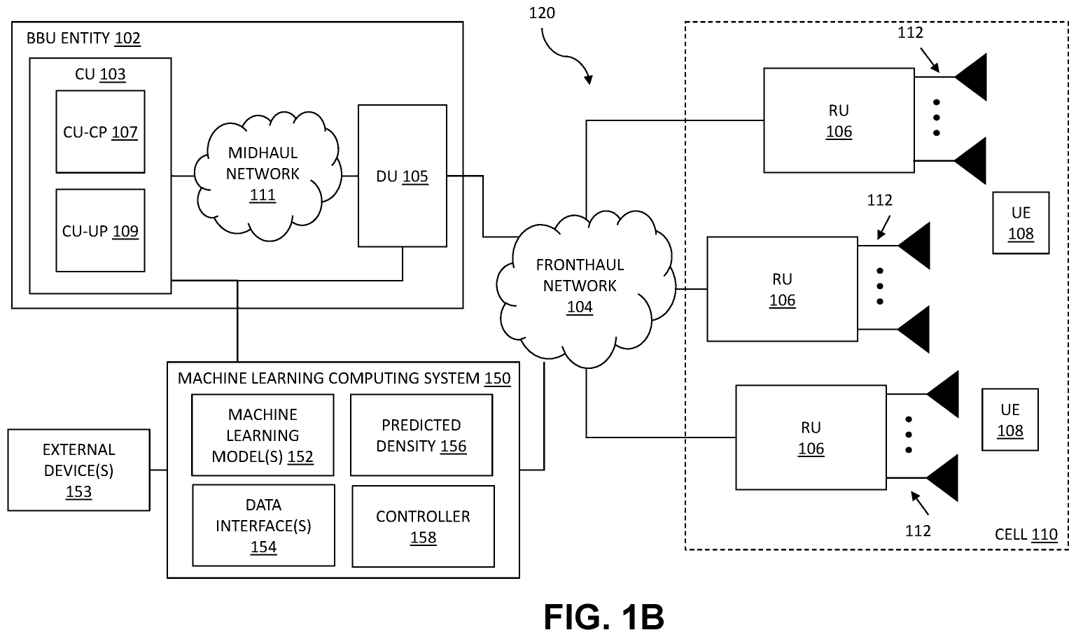

FIG. 1A is a block diagram illustrating an example base station 100 in which the techniques for providing a target location and/or directions in a campus or venue network described herein can be implemented. In the particular example shown in FIG. 1A, the base station 100 includes one or more baseband unit (BBU) entities 102 communicatively coupled to a RU 106 via a fronthaul network 104. The base station 100 provides wireless service to various items of user equipment (UEs) 108 in a cell 110. Each BBU entity 102 can also be referred to simply as a “BBU.”

In the example shown in FIG. 1A, the one or more BBU entities 102 comprise one or more central units (CUs) 103 and one or more distributed units (DUs) 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 100. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RU 106 is configured to implement the control-plane and user-plane Layer-1 functions not implemented by the DU 105 as well as the radio frequency (RF) functions. The RU 106 is typically located remotely from the one or more BBU entities 102. In the example shown in FIG. 1A, the RU 106 is implemented as a physical network function (PNF) and is deployed in or near a physical location where radio coverage is to be provided in the cell 110. In the example shown in FIG. 1A, the RU 106 is communicatively coupled to the DU 105 using a fronthaul network 104. In some examples, the fronthaul network 104 is a switched Ethernet fronthaul network (for example, a switched Ethernet network that supports the Internet Protocol (IP)).

The RU 106 includes or is coupled to a set of antennas 112 via which downlink RF signals are radiated to UEs 108 and via which uplink RF signals transmitted by UEs 108 are received. In some examples, the set of antennas 112 includes two or four antennas. However, it should be understood that the set of antennas 112 can include two or more antennas 112. In one configuration (used, for example, in indoor deployments), the RU 106 is co-located with its respective set of antennas 112 and is remotely located from the one or more BBU entities 102 serving it. In another configuration (used, for example, in outdoor deployments), the antennas 112 for the RU 106 are deployed in a sectorized configuration (for example, mounted at the top of a tower or mast). In such a sectorized configuration, the RU 106 need not be co-located with the respective sets of antennas 112 and, for example, can be located at the base of the tower or mast structure, for example, and, possibly, co-located with its serving one or more BBU entities 102.

While the example shown in FIG. 1A shows a single CU-CP 107, a single CU-UP 109, a single DU 105, and a single RU 106 for the base station 100, it should be understood that this is an example and other numbers of BBU entities 102, components of the BBU entities 102, and/or other numbers of RUs 106 can also be used.

FIG. 1B is a block diagram illustrating an example base station 120 in which the techniques for providing a target location and/or directions in a campus or venue network described herein can be implemented. In the particular example shown in FIG. 1B, the base station 120 includes one or more BBU entities 102 communicatively coupled to multiple radio units RU 106 via a fronthaul network 104. The base station 120 provides wireless service to various UEs 108 in a cell 110. Each BBU entity 102 can also be referred to simply as a “BBU.”

In the example shown in FIG. 1B, the one or more BBU entities 102 comprise one or more CUs 103 and one or more DUs 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 120. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RUs 106 are configured to implement the control-plane and user-plane Layer-1 functions not implemented by the DU 105 as well as the radio frequency (RF) functions. Each RU 106 is typically located remotely from the one or more BBU entities 102 and located remotely from other RUs 106. In the example shown in FIG. 1B, each RU 106 is implemented as a physical network function (PNF) and is deployed in or near a physical location where radio coverage is to be provided in the cell 110. In the example shown in FIG. 1B, the RUs 106 are communicatively coupled to the DU 105 using a fronthaul network 104. In some examples, the fronthaul network 104 is a switched Ethernet fronthaul network (for example, a switched Ethernet network that supports the Internet Protocol (IP)).

Each of the RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include two or more antennas 112. In one configuration (used, for example, in indoor deployments), each RU 106 is co-located with its respective set of antennas 112 and is remotely located from the one or more BBU entities 102 serving it and the other RUs 106. In another configuration (used, for example, in outdoor deployments), the sets of antennas 112 for the RUs 106 are deployed in a sectorized configuration (for example, mounted at the top of a tower or mast). In such a sectorized configuration, the RUs 106 need not be co-located with the respective sets of antennas 112 and, for example, can be located at the base of the tower or mast structure, for example, and, possibly, co-located with the serving one or more BBU entities 102. Other configurations can be used.

The base stations 100, 120 that include the components shown in FIGS. 1A-1B can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the one or more BBU entities 102 (for example, the CU 103, CU-CP 107, CU-UP 109, and/or DU 105) are implemented as a software virtualized entities that are executed in a scalable cloud environment on a cloud worker node under the control of the cloud native software executing on that cloud worker node. In some such examples, the DU 105 is communicatively coupled to at least one CU-CP 107 and at least one CU-UP 109, which can also be implemented as software virtualized entities. In some other examples, one or more components of the one or more BBU entities 102 (for example, the CU-CP 107, CU-UP 109, and/or DU 105) are implemented as a single virtualized entity executing on a single cloud worker node. In some examples, the at least one CU-CP 107 and the at least one CU-UP 109 can each be implemented as a single virtualized entity executing on the same cloud worker node or as a single virtualized entity executing on a different cloud worker node. However, it is to be understood that different configurations and examples can be implemented in other ways. For example, the CU 103 can be implemented using multiple CU-UP VNFs and using multiple virtualized entities executing on one or more cloud worker nodes. Moreover, it is to be understood that the CU 103 and DU 105 can be implemented in the same cloud (for example, together in a radio cloud or in an edge cloud). In some examples, the DU 105 is configured to be coupled to the CU-CP 107 and CU-UP 109 over a midhaul network 111 (for example, a network that supports the Internet Protocol (IP)). Other configurations and examples can be implemented in other ways.

As discussed above, there is a need for improved distribution of detailed location information, services, and directions for safe locations in networks during emergency situations. To help facilitate this for the base station 100, 120, a machine learning computing system 150 is communicatively coupled to one or more components of the base station 100, 120. The machine learning computing system 150 is configured to predict density for different location areas in the cell 110, and one or more components of the network send a target location and/or directions to the target location based on the predicted density for location areas. In general, the predicted density relates to the amount of foot traffic, number of users, and/or number of UEs 108 in the different location areas in the cell 110.

In the examples shown in FIGS. 1A-1B, the machine learning computing system 150 is communicatively coupled to the BBU entity 102 and the RU(s) 106. In some examples, the machine learning computing system 150 is communicatively coupled to the CU 103, DU 105, and RUs 106. In other examples, the machine learning computing system 150 is communicatively coupled to a subset of the CU 103, DU 105, and RUs 106. In some examples, the machine learning computing system 150 is a general-purpose computing device (for example, a server) equipped with at least one (and optionally more than one) graphics processing unit (GPU) for faster machine-learning-based processing. In some examples, the machine learning computing system 150 is implemented in more than one physical housing, each with at least one GPU. The machine learning computing system 150 is a host for one or more machine learning models 152 that predict density for location areas in the cell 110 served by the base station 100, 120. In some examples, the machine learning computing system 150 is communicatively coupled to and configured to serve a single base station. In other examples, the machine learning computing system 150 is communicatively coupled to and configured to serve multiple base stations. The number of base stations that the machine learning computing system 150 is communicatively coupled to can be determined based on deployment needs and scale.

In some examples, the machine learning computing system 150 includes one or more interfaces 154 configured to receive time data. The time data can include, for example, the current time of day, day of the week, and/or whether the current day is a holiday. In some examples, the time data is provided by one or more external devices 153 that are separate and distinct from the machine learning computing system 150. For example, the one or more external devices 153 configured to provide time data to the machine learning computing system 150 can be a tracker, sensor, or Internet-of-Things (IoT) device. In other examples, at least a portion of the time data is provided by an internal component of the machine learning computing system 150 (for example, an internal clock).

In some examples, the machine learning computing system 150 also includes one or more interfaces 154 configured to receive location data. The location data can include, for example, the current location area within the cell 110 for which a density prediction is to be determined. The cell 110 is divided into the different location areas prior to deployment and operation of the base station 100, 120. The location areas are associated with a unique geographic region within the cell 110, and each location area in the cell 110 has a corresponding identifier associated with it (for example, a zip code). In some examples, each location area has a circular shape with a radius of approximately 10 feet, which is the accuracy of GPS in the worst case for UEs 108. In other examples, each location area has a different shape (for example, square or rectangular) with a width of approximately 10 feet. Other size location areas could also be utilized. Depending on the size of the campus or venue, the cell 110 can have hundreds or thousands of location areas. In some examples, the location data is provided by one or more external devices 153 that are separate and distinct from the machine learning computing system 150. In other examples, the location data is provided by an internal component of the machine learning computing system 150.

The machine learning computing system 150 includes a machine learning model 152 that is configured to determine predicted density 156 for different location areas of the cell 110 based on the time data and the location data. In some examples, the machine learning computing system 150 is configured to determine a predicted density 156 for each of the location areas of the cell 110 at a particular time or time period (for example, during an emergency). In other examples, the machine learning computing system 150 is configured to determine a predicted density 156 for a subset of the location areas of the cell 110 that depends on the type of alert or emergency.

In some examples, the machine learning model 152 is a multinomial regression model, and the machine learning computing system 150 utilizes the time data and the location data as independent variables in a predictor function of the machine learning model 152. In such examples, the predicted density 156 of location areas in the cell 110 is the dependent variable in the predictor function of the machine learning model 152. Each independent variable in the predictor function is associated with a specific weight/coefficient determined via training and the weights/coefficients can be updated during operation of the system.

The time data (including current time of day and day of week) is encoded and used by the machine learning model 152 in a manner that does not apply a higher weight to a particular time of day by default (for example, where 11:00 AM is weighted higher than 10:00 AM by virtue of being associated with a larger number). In some examples, the time of day is divided into segments (for example, 15-minute increments) and the predictor function utilizes a binary variable for indicating that the current time falls within a particular segment. For example, a one can be used to indicate that the current time is within a particular time segment, and a zero can be used to indicate that the current time is not within a particular segment. Similarly, the predictor function can utilize a binary variable for indicating that the current day of the week is a particular day of the week. For example, a one can be used to indicate that the current day of the week is a particular day of the week, and a zero can be used to indicate that the current day of the week is not a particular day of the week.

In examples where the time data also includes information regarding whether the current day is a holiday, this information is also encoded and used by the machine learning model 152 in a manner that does not apply a higher weight to a particular holiday by default. In some examples, the information regarding whether the current day is a holiday can be indicated using a binary variable such that any day that is a holiday will be encoded as a first state (for example, using a one) and any day that is not a holiday will be encoded as the other state (for example, using a zero). In other examples, each specific holiday can be associated with a different independent variable that is binary in a manner similar to the time segments discussed above.

In some examples, the location data (including the location area identifier) is encoded and used by the machine learning model 152 in a manner that does not apply a higher weight to a particular location area by default (for example, where a location area identifier is weighted higher than a different location area identifier by virtue of being associated with a larger number). In some examples, the location data is divided into segments (for example, each location area as a separate independent variable) and the predictor function utilizes a binary variable for indicating that the current location area being considered falls within a particular segment. For example, a one can be used to indicate that the current location area identifier is within a particular location segment, and a zero can be used to indicate that the current location area identifier is not within a particular location segment.

In some examples, the predicted density 156 output by the machine learning model 152 indicates a numerical range of users present in a particular location area of the zone that includes in the base station 100, 120. In some examples, each numerical range of users is encoded as a distinct output (dependent variable) of the predictor function of the machine learning model 152. In some examples, the output of the machine learning model 152 is an integer that corresponds to the particular numerical range of users. Each distinct output corresponds to a different numerical range of users for a particular location area.

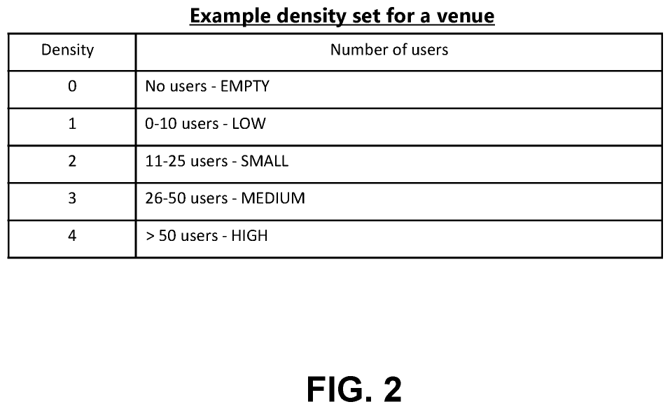

While different densities can be encoded as a numerical output, the numerical output represents additional information that is assumed in the machine learning model 152. In some examples, each density corresponds to different amounts of users in the location area. A simplified table of the density and associated numbers of users in the location area is shown in FIG. 2. In the example shown in FIG. 2, the number of users associated with each numerical output corresponding to a particular density and the level of the density (for example, empty, low, small, medium, high) increases as the numerical output value increases. Also, in the example shown in FIG. 2, the range of the number of UEs associated with each numerical output corresponding to a particular density increases as the numerical output value increases. However, it should be understood that the number of numerical outputs, which corresponds to the granularity of the density prediction, and the ranges of the number of UEs associated with each numerical output could be different. The particular ranges that correspond to an output can be selected based on the specific needs and desired performance of the network. The values for the ranges in each machine learning model 152 will vary depending on the particular independent variables and scope of that particular machine learning model 152.

In order to reliably predict the density for the location areas, the machine learning model 152 is trained in order to determine the weights/coefficients using supervised learning prior to operation. In some examples, synthetic (non-real world) time data and location data is generated for the independent variables and synthetic density data for the location areas is generated for dependent variables. In other examples, sensors can be distributed throughout the cell to generate measured time data, location data, and/or density data that is used for training. In some examples, the weights/coefficients are determined using an iterative procedure or other supervised learning training techniques. In some examples, the objective for training the machine learning model 152 is to predict the density for the location areas for particular time data to a desired level of accuracy. In some examples, approximately thirty data points per location area are needed in order to assure that the accuracy of the machine learning model 152 is above 95%.

Once the machine learning model 152 is trained, the machine learning computing system 150 is configured to use the time data and the location data as inputs for the machine learning model 152 and determine a predicted density 156 for location areas in the cell 110. In some examples, the machine learning computing system 150 is configured to perform additional learning during operation and adapt the weights/coefficients based on real world time data, location data, and/or density data (for example, estimated number of UEs 108 in a location area). Other performance parameters can also be used for the additional learning during operation.

In some examples, the number of independent variables of the machine learning model 152 can be selected during training based on the desired level of accuracy and computational load demands for the machine learning model 152. In theory, a greater number of independent variables for the time data and location data can provide a more accurate prediction of the density for location areas of a zone that includes the base station assuming that the machine learning model 152 is sufficiently trained. However, the computational load demands and the time required for training increase when using a higher number of independent variables.

In some examples, the number of possible distinct outputs (for example, number of density categories) of the machine learning model 152 can be selected during training based on the needs and capabilities of the system. Some factors that can be used to determine the number of distinct outputs can include capacity of the location areas, capacity of target locations, and the like. In general, the number of users that can be present in a location area is limited by the size of the location area. A greater number of possible distinct outputs of the machine learning model 152 could help provide better target locations and directions for users in an emergency compared to a lower number of possible distinct outputs due to a more granular density prediction. However, the machine learning model 152 will likely take longer to train if there is a large number of possible distinct outputs.

While a single machine learning model 152 may provide sufficient accuracy for some applications, it may be desirable or necessary to increase the accuracy of the predicted density 156 for location areas in the cell 110. One potential approach for increasing the accuracy of the predicted density 156 for location areas in the cell 110 is to use multiple machine learning models 152 that are each specific to a subset of the time data and/or location data. This approach reduces the number of independent variables, which reduces the complexity of the predictor function and can result in reduced computational load and/or increased accuracy of the output.

In some examples, multiple machine learning models 152 directed to specific subsets of the time data are utilized by the machine learning computing system 150. In some such examples, each respective machine learning model 152 is directed to a particular time of day (for example, morning, afternoon, or evening). In other such examples, each respective machine learning model 152 is directed to a particular day of the week (for example, Monday, Tuesday, etc.) or grouped day of the week (for example, weekdays or weekends). In other such examples, each respective machine learning model 152 is directed to a particular holiday status (for example, holiday or non-holiday).

In some examples, multiple machine learning models 152 directed to specific subsets of the location data are utilized by the machine learning computing system 150. In some such examples, each respective machine learning model 152 is directed to a specific sub-area of the cell 110 and uses only location data for that specific sub-area as an input. In such examples, each sub-area can include a group of multiple location areas in the cell 110.

In some examples, multiple machine learning models 152 directed to a combination of the subsets discussed above can be used to increase the accuracy of the predicted density 156.

In some examples, one or more components of the system (for example, a controller 158 of the machine learning computing system 150, BBU entity 102, and/or RUs 106) are configured to select a target location from a plurality of predetermined target locations based on the predicted density 156 for different location areas. In some examples, the predetermined target locations correspond to zones or locations designated for users to go during a particular type of emergency or alert. For example, if there is a tornado warning, the predetermined target locations may be a number of safe zones within an interior of a building. In such examples, the venue or campus operator identifies the zones or locations for each particular type of emergency or alert and provides information (for example, capacity of the zone/location, coordinates, etc.) for the zones or locations prior to operation. The component(s) of the system select which of the zones or locations to direct a user to based on the predicted density 156 for different location areas. In some examples, the component(s) of the system can select one of the zones or locations that has the lowest predicted density 156.

The component(s) of the system can also use a number of other factors to select the target location in addition to the predicted density 156 for different location areas. For example, the component(s) of the system can use a location of the UE 108, a type of emergency or alert that is active in the cell 110, and/or the number of additional users being directed to the target locations. For example, the component(s) of the system can select a target location that is closest to the current location of the UE 108, corresponds to the type of emergency or alert active in the cell 110 (flood, tornado, active shooter, etc.), and that does not have a predicted density 156 that exceeds its capacity even when accounting for additional users being directed to the target location. The location of the UE 108 can be obtained directly from the network (for example, the BBU entity 102), directly from the UE 108 (for example, if GPS is turned on and the user has allowed the location to be shared), or using a UE assisted technique as allowed by 3GPP specifications. In some examples, the predetermined target locations correspond to safe zone(s)/location(s) that are specifically used for a particular alert/emergency or for multiple alerts/emergencies.

The component(s) of the system are configured to provide the selected target location to a UE 108. In some examples, the component(s) are configured to provide the selected target location to the UE 108 through a message (for example, a Short Message Service (SMS) message), a Wireless Emergency Alert (WEA), or through an application provided for the user.

In some examples, the component(s) of the system are configured to provide a map showing the target location to the UE 108. In some such examples, the component(s) of the system obtain a map from a third party (for example, Google Maps, Apple Maps, etc.) and send the map to the user as a separate message (for example, a Short Message Service (SMS) message) or through an application provided for the user.

In some examples, the component(s) of the system are configured to provide directions to the target location to a UE 108 based on the predicted density 156 and the location of the UE 108. In some such examples, the component(s) of the system obtain directions from a third party (for example, Google Maps, Apple Maps, etc.) and send the directions to the user as a separate message (for example, a Short Message Service (SMS) message) or through an application provided for the user.

In some examples, the component(s) of the system are configured to provide directions to users via lights (for example, LED lights) and/or signs in the venue or campus network based on the predicted density 156. In some examples, the component(s) of the system are communicatively coupled to the lights and/or signs included on the walls or ceilings in a venue, and the component(s) of the system can enable/disable, modify the color, modify the flash periodicity, or otherwise control the lights and/or signs to indicate directions to the target locations based on the predicted density 156. In some such examples, users in different location areas are directed to different target locations based on the predicted density 156 and, for example, the capacity of the target locations. In examples where the machine learning computing system 150 is configured to provide the directions, the machine learning computing system 150 provides control signals to the lights and/or signs (external devices 153) via one or more interfaces 154.

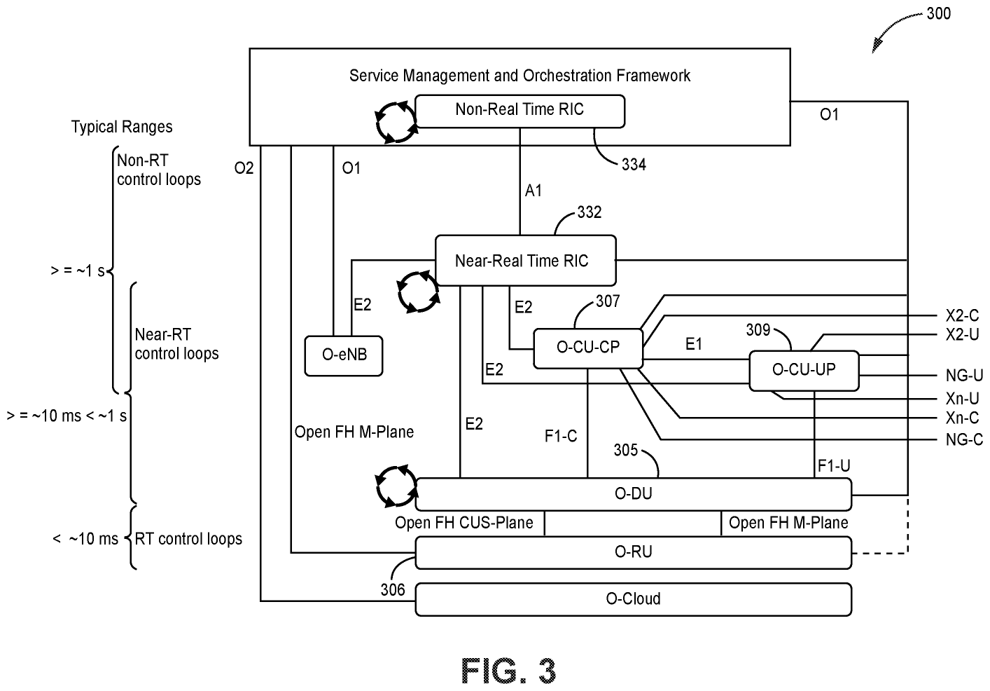

FIG. 3 is a block diagram illustrating an example base station 300 in which the techniques for radio resource usage described herein can be implemented. In the particular example shown in FIG. 3, the base station 300 includes one or more central units (CUs), one or more distributed units (DUs), and one or more radio units (RUs). Each RU is located remotely from each CU and DU serving it.

The base station 300 is implemented in accordance with one or more public standards and specifications. In some examples, the base station 300 is implemented using the logical RAN nodes, functional splits, and front-haul interfaces defined by the Open Radio Access Network (O-RAN) Alliance. In the example shown in FIG. 3, each CU, DU, and RU is implemented as an O-RAN central unit (O-CU), O-RAN distributed unit (O-DU) 305, and O-RAN radio unit (O-RU) 306, respectively, in accordance with the O-RAN specification.

In the example shown in FIG. 3, the base station 300 includes a single O-CU, which is split between an O-CU-CP 307 that handles control-plane functions and an O-CU-UP 309 that handles user-plane functions. The O-CU comprises a logical node hosting Packet Data Convergence Protocol (PDCP), Radio Resource Control (RRC), Service Data Adaptation Protocol (SDAP), and other control functions. Therefore, each O-CU implements the gNB controller functions such as the transfer of user data, mobility control, radio access network sharing, positioning, session management, etc. The O-CU(s) control the operation of the O-DUs 305 over an interface (including F1-C and F1-U for the control plane and user plane, respectively).

In the example shown in FIG. 3, the single O-CU handles control-plane functions, user-plane functions, some non-real-time functions, and/or PDCP processing. The O-CU-CP 307 may communicate with at least one wireless service provider's Next Generation Cores (NGC) using a 5G NG-c interface and the O-CU-UP 309 may communicate with at least one wireless service provider's NG-C using a 5G NG-U interface.

Each O-DU 305 comprises a logical node hosting (performing processing for) Radio Link Control (RLC) and Media Access Control (MAC) layers, as well as optionally the upper or higher portion of the Physical (PHY) layer (where the PHY layer is split between the DU and RU). In other words, the O-DUs 305 implement a subset of the gNB functions, depending on the functional split (between O-CU and O-DU 305). In some configurations, the Layer-3 processing (of the 5G air interface) may be implemented in the O-CU and the Layer-2 processing (of the 5G air interface) may be implemented in the O-DU 305.

The O-RU 306 comprises a logical node hosting the portion of the PHY layer not implemented in the O-DU 305 (that is, the lower portion of the PHY layer) as well as implementing the basic RF and antenna functions. In some examples, the O-RUs 306 may communicate baseband signal data to the O-DUs 305 on Open Fronthaul CUS-Plane or Open Fronthaul M-plane interface. In some examples, the O-RU 306 may implement at least some of the Layer-1 and/or Layer-2 processing. In some configurations, the O-RUs 306 may have multiple ETHERNET ports and can communicate with multiple switches.

Although the O-CU (including the O-CU-CP 307 and O-CU-UP 309), O-DU 305, and O-RUs 306 are described as separate logical entities, one or more of them can be implemented together using shared physical hardware and/or software. For example, in the example shown in FIG. 3, for each cell, the O-CU (including the O-CU-CP 307 and O-CU-UP 309) and O-DU 305 serving that cell could be physically implemented together using shared hardware and/or software, whereas each O-RU 306 would be physically implemented using separate hardware and/or software. Alternatively, the O-CU(s) (including the O-CU-CP 307 and O-CU-UP 309) may be remotely located from the O-DU(s) 305.

In the example shown in FIG. 3, the base station 300 further includes a non-real time RAN intelligent controller (RIC) 334 and a near-real time RIC 332. The non-real time RIC 334 and the near-real time RIC 332 are separate entities in the O-RAN architecture and serve different purposes. In some examples, the non-real time RIC 334 is implemented as a standalone application in a cloud network. In other examples, the non-real time RIC 334 is integrated with a Device Management System (DMS) or Service Orchestration (SO) tool. In some examples, the near-real time RIC 332 is implemented as a standalone application in a cloud network. In other examples, the near-real time RIC 332 is embedded in the O-CU. The non-real time RIC 334 and/or the near-real time RIC 332 can also be deployed in other ways.

The non-real time RIC 334 is responsible for non-real time flows in the system (typically greater than or equal to 1 second) and configured to execute one or more machine learning models, which are also referred to as “rApps.” The near-real time RIC 332 is responsible for near-real time flows in the system (typically 10 ms to 1 second) and configured to execute one or more machine learning models, which are also referred to as “xApps.”

In some examples, the near-real time RIC 332 shown in FIG. 3 can be configured to operate in a manner similar to the machine learning computing system 150 described above with respect to FIGS. 1A-2. In some such examples, the functionality of the machine learning computing system 150 is implemented as an xApp that is configured to run on the near-real time RIC 332. The near-real time RIC 332 is configured to predict density of location areas in the cell in a manner similar to that described above, and one or more components of the base station 300 are configured to determine a target location and provide the target location and/or directions to the target location to one or more UEs in the cell.

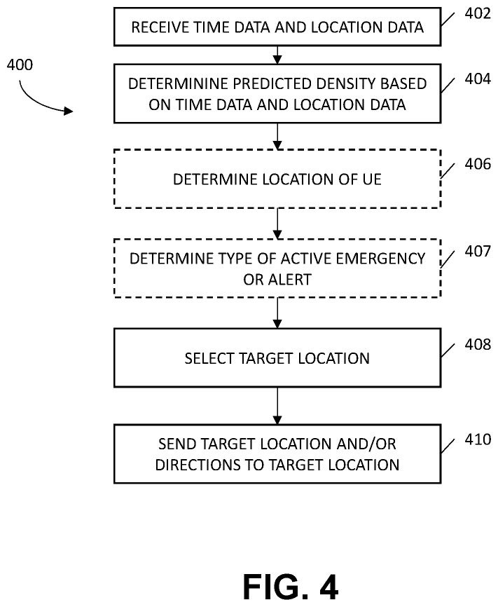

FIG. 4 illustrates a flow diagram of an example method 400 for providing machine learning based location and/or direction information to a user in a campus or venue network. The common features discussed above with respect to the base stations in FIGS. 1A-3 can include similar characteristics to those discussed with respect to method 400 and vice versa. In some examples, the method 400 is performed by a base station (for example, base station 100, 120, 300).

The blocks of the flow diagram in FIG. 4 have been arranged in a generally sequential manner for ease of explanation; however, it is to be understood that this arrangement is merely exemplary, and it should be recognized that the processing associated with method 400 (and the blocks shown in FIG. 4) can occur in a different order (for example, where at least some of the processing associated with the blocks is performed in parallel in an event-driven manner).

The method 400 includes receiving time data and location data (block 402). In some examples, the time data includes the current time of day, the current day of the week, and/or whether the current day is a holiday. In some examples, the location data can include the current location area within the cell for which a density prediction is to be determined.

The method 400 further includes determining predicted density based on the time data and the location data (block 404). In some examples, determining the predicted density includes predicting the foot traffic or number of users in different location areas of the cell. The predicted density is determined using one or more machine learning models in a manner similar to that discussed above.

The method 400 optionally includes determining a location of a UE (block 406). In some examples, the location of the UE can be obtained directly from the network (for example, the BBU entity), directly from the UE (for example, if GPS is turned on and the user has allowed the location to be shared), or using a UE assisted technique as allowed by 3GPP specifications. In some examples, determining the location of the UE includes determining the location area where the UE is currently positioned. In some such examples, the location of the UE determined using the above techniques is associated with a location area (for example, using a lookup table or other type of file with information regarding the geographical position of the location areas in the cell).

The method 400 also optionally includes determining a type of active emergency or alert (block 407). In some examples, determining the type of active emergency or alert includes receiving an input from an external system indicating the emergency or alert. Some example emergencies/alerts include E911 calls, Earthquake and Tsunami Warning System (ETWS) alerts, Commercial Mobile Alert System (CMAS) alerts, weather alerts, active shooter warnings, or the like. The input can be received from the organization issuing the alert (for example, from the weather service, police department, fire department, etc.), from a third party (for example, from a weather app, neighborhood social media app, etc.), or from another source.

The method 400 further includes selecting a target location for the UE based on the predicted density (block 408). In some examples, the target location is selected from a group of predetermined target locations, which can be identified by a venue or campus operator. In some examples, the selection of the target location can be based on additional information beyond the predicted density. For example, the target location can be selected based on information about the target location (for example, capacity), the location of the UE (if determined at block 406), the type of emergency or alert active in the cell (if determined at block 407), and/or a number of additional users being directed to the target location.

The method 400 further includes sending the determined target location and/or directions to the determined target location to the UE (block 410). In some examples, the target location and/or directions are provided by the system to the UE through a message (for example, a Short Message Service (SMS) message), a Wireless Emergency Alert (WEA), an application provided for the user, or some other manner. In some examples, directions from the location of the UE to the selected target location are obtained from a third-party application.

In some examples, directions are provided to users via lights (for example, LED lights) and/or signs in the venue or campus network based on the predicted density and needs in addition to, or instead of, providing directions to the determined target location to specific UEs. In some examples, the lights and/or signs can be included on the walls or ceilings in a venue, and the component(s) of the system can enable/disable, modify the color, modify the flash periodicity, or otherwise control the lights and/or signs to indicate directions to the target locations based on the predicted density. In some such examples, users in different location areas are directed to different target locations based on the predicted density and, for example, the capacity of the target locations.

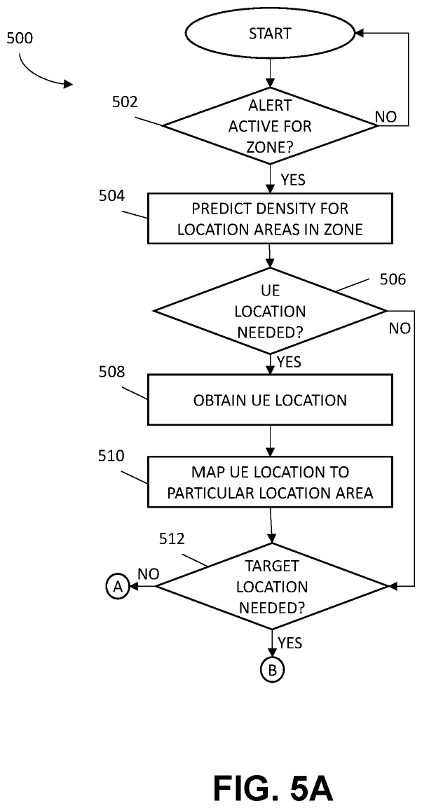

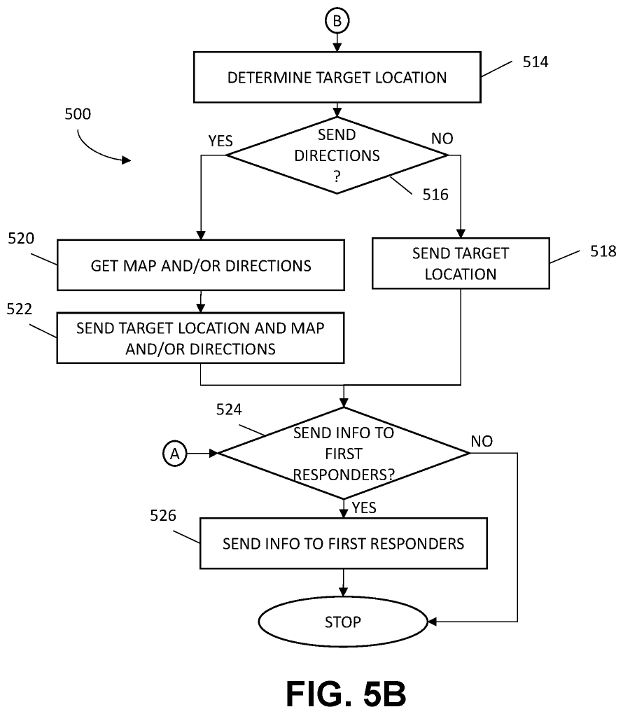

FIGS. 5A-5B illustrate a flow diagram of an example method 500 for providing machine learning based location and directions for venue and campus networks. The common features discussed above with respect to the base stations in FIGS. 1A-3 can include similar characteristics to those discussed with respect to method 500 and vice versa. In some examples, the method 400 is performed by a base station (for example, base station 100, 120, 300).

The blocks of the flow diagram in FIGS. 5A-5B have been arranged in a generally sequential manner for ease of explanation; however, it is to be understood that this arrangement is merely exemplary, and it should be recognized that the processing associated with method 500 (and the blocks shown in FIGS. 5A-5B) can occur in a different order (for example, where at least some of the processing associated with the blocks is performed in parallel in an event-driven manner).

The method 500 begins with determining whether there is an active alert for the zone serviced by the base station (block 502). In some examples, this determination can be made based on whether an alert has been received from an external system indicating the alert. In some examples, the alert can include E911 calls, Earthquake and Tsunami Warning System (ETWS) alerts, Commercial Mobile Alert System (CMAS) alerts, weather alerts, active shooter warnings, or the like.

If there is no active alert, the method 500 repeats the determination in block 502. In some examples, the determination is periodically repeated (for example, every minute).

If there is an active alert, the method 500 proceeds with determining predicted density for a plurality of location areas for a zone serviced by the base station (block 504). In some examples, predicting density includes predicting the foot traffic or number of users in different location areas of the zone (for example, a cell). The predicted density is determined using one or more machine learning models in a manner similar to that discussed above. The density is predicted based on the time data and the location data received by a machine learning computing system that includes one or more machine learning models as discussed above. In some examples, the time data includes the current time of day, the current day of the week, and/or whether the current day is a holiday. In some examples, the location data can include the current location area within the cell for which a density prediction is to be determined.

The method 500 further includes determining whether a location of a UE is needed (block 506). In some examples, determining whether the location of the UE is needed is based on the type of emergency or alert that is active since the location of the UE may not be required for some emergencies and alerts. If the location of the UE is not needed, the method 500 proceeds to block 512, which is discussed below.

If the location of the UE is needed, the method 500 proceeds with obtaining the UE location (block 508). In some examples, the location of the UE can be obtained directly from the network (for example, the BBU entity), directly from the UE (for example, if GPS is turned on and the user has allowed the location to be shared), or using a UE assisted technique as allowed by 3GPP specifications. In some examples, determining the location of the UE includes determining the location area where the UE is currently positioned.

In some examples, the method 500 proceeds to mapping the UE location to a particular location area in the cell (block 510). In some such examples, the location of the UE determined using the above techniques is mapped to a location area using a lookup table or other type of file with information regarding the geographical position of the location areas in the cell.

The method 500 further includes determining whether a target location is needed (block 512). In some examples, determining whether the target location is needed is based on the type of emergency or alert that is active since a specific target location may not be required for some emergencies and alerts. If the target location is not needed, the method 500 proceeds to block 524, which is discussed below.

If the target location is needed, the method 500 proceeds with determining the target location (block 514). In some examples, determining the target location includes selecting the target location from a group of predetermined target locations, which can be identified by a venue or campus operator. In some examples, the selection of the target location can be based on additional information beyond the predicted density. For example, the target location can be selected based on information about the target locations (for example, capacity), the location of the UE (if obtained at block 508), the type of emergency or alert active in the cell, and/or a number of additional users being directed to the target locations.

The method 500 proceeds with determining whether directions to the target location should be sent to the UE (block 516). In some examples, determining whether directions to the target location should be sent is based on the type of emergency or alert that is active since specific directions may not be required for some emergencies and alerts. For example, if the target location is a more generalized area (interior of the building during a tornado warning or top floor during a flood warning), then specific directions may not be required since a general description of the target location may be sufficient.

If directions to the target location are not to be sent, the method 500 proceeds with sending the target location to the UE (block 518). In some examples, the target location is provided by the system to the UE through a message (for example, a Short Message Service (SMS) message), a Wireless Emergency Alert (WEA), an application provided for the user, or in some other suitable manner.

If directions to the target location are to be sent, the method 500 proceeds with obtaining a map of the zone and/or directions to the target location (block 520). In some examples, obtaining a map and/or directions includes obtaining the map and/or directions from a third party (for example, Google Maps, Yahoo Maps, etc.).

The method 500 proceeds with sending the target location and the map and/or directions to the UE (block 522). In some examples, the map and/or directions are provided by the system to the UE through a message (for example, a Short Message Service (SMS) message), a Wireless Emergency Alert (WEA), an application provided for the user, or in some other suitable manner.

In some examples, directions are provided to users via lights (for example, LED lights) and/or signs in the venue or campus network based on the predicted density and needs in addition to, or instead of, providing directions to the determined target location to specific UEs. In some examples, the lights and/or signs can be included on the walls or ceilings in a venue, and the component(s) of the system can enable/disable, modify the color, modify the flash periodicity, or otherwise control the lights and/or signs to indicate directions to the target locations based on the predicted density. In some such examples, users in different location areas are directed to different target locations based on the predicted density and, for example, the capacity of the target locations.

The method 500 proceeds with determining whether information should be sent to first responders (block 524). In some examples, the information includes the location of the UE and/or the target locations where users are directed. In some examples, determining whether information should be sent to first responders includes determining whether a UE has provided permission for the location of the UE to be provided to first responders. In some such examples, the UE is prompted to share its location with first responders through a message or in an application provided for the user.

If information is not to be sent to the first responders, the method 500 terminates. If information is to be sent to the first responders, the method 500 proceeds with sending the information to the first responders (block 526) and then terminates. In some examples, the information is sent to the first responders by one or more components the base station. In some examples, the information is sent to the first responders by the UE directly. Other examples are implemented in other ways.

The example techniques described herein enhance the user experience and the safety and security of a venue or campus for end users. By using the predicted density to determine the target location and directions, the systems and methods provide a better and safer experience for end users, at least in part, because the likelihood of directing too many users to a safe zone/location (such that the capacity of safe zone/location is exceeded) is reduced. Also, by predicting the density using the machine learning computing system, the systems and methods described herein can provide the target location and directions to end users with lower latency compared to techniques that rely on density information collected in real-time. Further, the techniques described herein enable the first responders to aid end users during emergencies in an aggregated manner (for example, at the target locations) or in an individual manner (for example, using the locations of the UEs provided in an on-demand manner).

While the primary examples described herein relate to emergency alerts, it should be understood that the systems and methods described herein could also be utilized for other applications. In other examples, the alerts could be related to a non-emergency event (for example, a sale or a concert). In such examples, the target locations could be a store or an end user's seat at the venue, and the directions to the store or seat can be determined using the density predicted by the machine learning computing system in order to provide the least crowded route to the target locations. Other variations and applications could also be implemented using techniques similar to those described herein.

The systems and methods described herein may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### EXAMPLE EMBODIMENTS

Example 1 includes a system, comprising: at least one baseband unit (BBU) entity; one or more radio units communicatively coupled to the at least one BBU entity; one or more antennas communicatively coupled to the one or more radio units, wherein each respective radio unit of the one or more radio units is communicatively coupled to a respective subset of the one or more antennas; wherein the at least one BBU entity, the one or more radio units, and the one or more antennas are configured to implement a base station for wirelessly communicating with user equipment in a cell; and a machine learning computing system configured to receive time and location data and determine a predicted density for a plurality of location areas in the cell based on the time and location data; wherein the system is configured to: determine a target location based on the predicted density for the plurality of location areas in the cell; and send the target location to a first user equipment in the cell.

Example 2 includes the system of Example 1, wherein the time and location data includes: a time of day; a day of week; and an identifier for at least one location area of the plurality of location areas in the cell.

Example 3 includes the system of any of Examples 1-2, wherein the system is further configured to determine a location of the first user equipment.

Example 4 includes the system of Example 3, wherein the system is further configured to send, to the first user equipment, directions from the location of the first user equipment to the target location.

Example 5 includes the system of any of Examples 3-4, wherein the system is configured to determine the target location based on the location of the first user equipment.

Example 6 includes the system of any of Examples 3-5, wherein the system is further configured to send the location of the first user equipment to a first responder.

Example 7 includes the system of any of Examples 1-6, wherein the system is further configured to determine the target location by selecting the target location from a plurality of predetermined target locations in the cell.

Example 8 includes the system of any of Examples 1-7, wherein the system is further configured to determine a type of active emergency or alert in the cell, wherein the system is configured to determine the target location based on the type of active emergency or alert in the cell.

Example 9 includes the system of any of Examples 1-8, wherein the machine learning computing system is configured to utilize the time and location data as inputs to a plurality of machine learning models, wherein each machine learning model of the plurality of machine learning models is directed to a respective sub-area of the cell.

Example 10 includes the system of any of Examples 1-9, wherein the machine learning computing system is configured to utilize the time and location data as inputs to a plurality of machine learning models, wherein each machine learning model of the plurality of machine learning models is directed to a respective building or venue.

Example 11 includes the system of any of Examples 1-10, wherein the one or more radio units includes a plurality of radio units, wherein the one or more antennas includes a plurality of antennas, wherein the at least one BBU entity includes a central unit communicatively coupled to a distributed unit, wherein the distributed unit is communicatively coupled to the one or more radio units, wherein the machine learning computing system is implemented in a radio access network intelligent controller.

Example 12 includes the system of any of Examples 1-11, wherein the system is configured to provide directions to the target location via lights and/or signs of a venue, wherein the system is configured to send control signals to the lights and/or signs of the venue to enable/disable the lights and/or signs.

Example 13 includes a method, comprising: receiving time data and location data; determining a predicted density for a plurality of location areas in a cell based on the time data and the location data, wherein at least one baseband unit (BBU) entity, one or more radio units, and one or more antennas are configured to implement a base station for wirelessly communicating with user equipment in the cell, wherein the one or more radio units communicatively coupled to the at least one BBU entity, wherein the one or more antennas are communicatively coupled to the one or more radio units, wherein each respective radio unit of the one or more radio units is communicatively coupled to a respective subset of the one or more antennas; determining a target location based on the predicted density for the plurality of location areas in the cell; and sending the target location to a first user equipment in the cell.

Example 14 includes the method of Example 13, wherein the time data and the location data includes: a time of day; a day of week; and an identifier for at least one location area of the plurality of location areas in the cell.

Example 15 includes the method of any of Examples 13-14, further comprising determining a location of the first user equipment.

Example 16 includes the method of Example 15, further comprising sending, to the first user equipment, directions from the location of the first user equipment to the target location.

Example 17 includes the method of any of Examples 15-16, wherein the method comprises determining the target location based on the predicted density for the plurality of location areas in the cell and the location of the first user equipment.

Example 18 includes the method of any of Examples 13-17, wherein determining the target location based on the predicted density for the plurality of location areas in the cell includes selecting the target location from a plurality of predetermined target locations in the cell.

Example 19 includes the method of any of Examples 13-18, further comprising determining a type of active emergency or alert in the cell, wherein the method comprises determining the target location based on the predicted density for the plurality of location areas in the cell and the type of active emergency or alert in the cell.

Example 20 includes the method of any of Examples 13-19, further comprising providing directions to the target location via lights and/or signs of a venue by sending control signals to the lights and/or signs of the venue to enable/disable the lights and/or signs.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system, comprising:
at least one baseband unit (BBU) entity;
one or more radio units communicatively coupled to the at least one BBU entity;
one or more antennas communicatively coupled to the one or more radio units, wherein each respective radio unit of the one or more radio units is communicatively coupled to a respective subset of the one or more antennas;
wherein the at least one BBU entity, the one or more radio units, and the one or more antennas are configured to implement a base station for wirelessly communicating with user equipment in a cell; and
a machine learning computing system configured to receive time and location data and determine a predicted density for a plurality of location areas in the cell based on the time and location data;
wherein the system is configured to:
determine a target location based on the predicted density for the plurality of location areas in the cell; and
send the target location to a first user equipment in the cell.

2. The system of claim 1, wherein the time and location data includes:
a time of day;
a day of week; and
an identifier for at least one location area of the plurality of location areas in the cell.

3. The system of claim 1, wherein the system is further configured to determine a location of the first user equipment.

4. The system of claim 3, wherein the system is further configured to send, to the first user equipment, directions from the location of the first user equipment to the target location.

5. The system of claim 3, wherein the system is configured to determine the target location based on the location of the first user equipment.

6. The system of claim 3, wherein the system is further configured to send the location of the first user equipment to a first responder.

7. The system of claim 1, wherein the system is further configured to determine the target location by selecting the target location from a plurality of predetermined target locations in the cell.

8. The system of claim 1, wherein the system is further configured to determine a type of active emergency or alert in the cell, wherein the system is configured to determine the target location based on the type of active emergency or alert in the cell.

9. The system of claim 1, wherein the machine learning computing system is configured to utilize the time and location data as inputs to a plurality of machine learning models, wherein each machine learning model of the plurality of machine learning models is directed to a respective sub-area of the cell.

10. The system of claim 1, wherein the machine learning computing system is configured to utilize the time and location data as inputs to a plurality of machine learning models, wherein each machine learning model of the plurality of machine learning models is directed to a respective building or venue.

11. The system of claim 1, wherein the one or more radio units includes a plurality of radio units, wherein the one or more antennas includes a plurality of antennas, wherein the at least one BBU entity includes a central unit communicatively coupled to a distributed unit, wherein the distributed unit is communicatively coupled to the one or more radio units, wherein the machine learning computing system is implemented in a radio access network intelligent controller.

12. The system of claim 1, wherein the system is configured to provide directions to the target location via lights and/or signs of a venue, wherein the system is configured to send control signals to the lights and/or signs of the venue to enable/disable the lights and/or signs.

13. A method, comprising:
receiving time data and location data;
determining a predicted density for a plurality of location areas in a cell based on the time data and the location data, wherein at least one baseband unit (BBU) entity, one or more radio units, and one or more antennas are configured to implement a base station for wirelessly communicating with user equipment in the cell, wherein the one or more radio units communicatively coupled to the at least one BBU entity, wherein the one or more antennas are communicatively coupled to the one or more radio units, wherein each respective radio unit of the one or more radio units is communicatively coupled to a respective subset of the one or more antennas;
determining a target location based on the predicted density for the plurality of location areas in the cell; and
sending the target location to a first user equipment in the cell.

14. The method of claim 13, wherein the time data and the location data includes:
a time of day;
a day of week; and
an identifier for at least one location area of the plurality of location areas in the cell.

15. The method of claim 13, further comprising determining a location of the first user equipment.

16. The method of claim 15, further comprising sending, to the first user equipment, directions from the location of the first user equipment to the target location.

17. The method of claim 15, wherein the method comprises determining the target location based on the predicted density for the plurality of location areas in the cell and the location of the first user equipment.

18. The method of claim 13, wherein determining the target location based on the predicted density for the plurality of location areas in the cell includes selecting the target location from a plurality of predetermined target locations in the cell.

19. The method of claim 13, further comprising determining a type of active emergency or alert in the cell, wherein the method comprises determining the target location based on the predicted density for the plurality of location areas in the cell and the type of active emergency or alert in the cell.

20. The method of claim 13, further comprising providing directions to the target location via lights and/or signs of a venue by sending control signals to the lights and/or signs of the venue to enable/disable the lights and/or signs.
